(19) United States
(12) Patent Application Publication
(10) Pub. No.: US 2024/0281743 A1
(43) Pub. Date: Aug. 22, 2024

(54) OIL SPILL RISK PREDICTION METHOD AND EARLY WARNING SYSTEM BASED ON ENVIRONMENTAL SENSITIVITY INDEX

(71) Applicant: China Waterborne Transport Research Institute, Beijing (CN)

(72) Inventors: Rongchang CHEN, Beijing (CN); Chen LIU, Beijing (CN)

(21) Appl. No.: 18/584,262

(22) Filed: Feb. 22, 2024

(30) Foreign Application Priority Data
Feb. 22, 2023 (CN) 2023101543856

(51) Int. Cl. G06Q 10/0637; G06Q 10/0635

(52) U.S. Cl. CPC G06Q 10/06375; G06Q 10/0635

(57) ABSTRACT

An oil spill risk prediction method and early warning system based on environmental sensitivity index, and the method comprises the following steps: step 1, selecting a potential oil spill accident site, and analyzing the oil spill pollution probability through a random statistical simulation method; step 2, based on the environmental sensitivity index, constructing a coastal zone ecological sensitivity evaluation index system based on the oil spill risk from three aspects of coastal classification, biological resources and human utilization resources; and step 3, predicting and evaluating the oil spill risk of the region by combining the oil spill pollution probability and the coastal zone ecological sensitivity evaluation index system. According to the method, the oil spilling risk can be accurately and timely estimated, early warning can be timely carried out, response can be timely made, and the method is of great significance to environmental protection and humanistic environment restoration.

### TECHNICAL FIELD

The present disclosure belongs to the field of environmental science and technology, and particularly relates to an oil spill risk prediction method and early warning system based on an environmental sensitivity index.

### BACKGROUND

Oil spill refers to the leakage of crude oil or oil products from the operation site or reservoir due to accidents or operational errors in the process of oil exploration, development, refining and transportation and storage. Oil spill at sea is a spill accident in the process of offshore exploitation, transportation, loading and unloading and use of oil, which will cause environmental pollution and ecological disaster to varying degrees.

The Environmental Sensitivity Index (ESI) is a coastline sensitivity index developed by the NOAA Agency for Toxic Articles Response Evaluation, which is used to make oil spill emergency response sensitivity map in coastal and Great Lakes areas of the United States. The Environmental Sensitivity Index (ESI) map is a compilation of information on coastline sensitivity, biological resources and human resources. This information is used to plan to develop a cleaning strategy before an accident, so that authorities are ready to take action in the event of such a leak. Planning ahead can reduce the harmful consequences of oil spill and cleaning.

At present, in the prior art, the prediction of oil film drift and diffusion after oil leakage into the sea generally adopts the method of typical scenario simulation, in which the meteorological conditions generally only consider the dominant wind and unfavorable wind direction, and the hydrological tidal current conditions generally only calculate the time of high tide and low tide. Prediction simulation is carried out through typical scenario combination. The wind direction and wind speed of actual sea conditions may change at any time. Different factors such as time, place, oil spill amount and dynamic conditions of oil spill accidents will lead to considerable uncertainty in the drift and diffusion path of oil spill and its pollution impact on sensitive protection targets in nearby sea areas.

### SUMMARY

In view of the above shortcomings in the prior art, it is an object of the present disclosure to provide an oil spill risk prediction method and early warning system based on an environmental sensitivity index.

In order to achieve the above object, the technical solutions adopted by the present disclosure are:
in a first aspect, there is provided an oil spill risk prediction method based on an environmental sensitivity index, the method including the following steps:
step 1, selecting a potential oil spill accident site, and analyzing the oil spill pollution probability through a random statistical simulation method;
step 2, based on the environmental sensitivity index, constructing a coastal zone ecological sensitivity evaluation index system based on the oil spill risk from three aspects of coastal classification, biological resources and human utilization resources; and
step 3, predicting and evaluating the oil spill risk of the region by combining the oil spill pollution probability and the coastal zone ecological sensitivity evaluation index system.

Further, the method of step 1 specifically includes the following sub-steps:
step 1-1, selecting a site of a possible oil spill accident according to the ship collision accident density, dividing the sea area around the oil spill accident that may be affected by pollution into a plurality of rectangular grids;
step 1-2, performing drift and diffusion trajectory simulation calculations of not less than 300 different scenarios in the last three years for the oil spill accident, the occurrence time of each accident scenario being uncertain, randomly selecting, at any moment in the past three years, the hourly monitoring data of a sea surface wind field under the corresponding conditions of wind speed and wind direction, and the flow field data, and adopting calculation region tidal current field simulation to calculate a result, wherein oil film drift elapsed time of each calculation grid unit and a pollution frequency parameter are calculated and recorded in each accident scenario simulation; and
Steps 1-3, according to the formula:

$$P ( i , j ) = \frac{M ( i , j )}{n} \times 100 \%$$

$$T ( i , j ) = Min \{ {T ( i , j )}_{n} \} , n = 1 , 2 , … , N$$

acquiring the pollution probability p (i, j) of the grid (i, j) by oil spill, and the minimum time T (i, j) for an oil film to drift to the grid (i, j) in N simulations; wherein i, j are delineated plane grid numbers; N is the total number of accident scenario simulations; M (i, j) is the number of times that the oil film drifts and diffuses to the grid (i, j) in N simulations.

Further, in step 2, the coastline classification are coastline environment sensitivity grading indices divided by certain criteria according to the sensitivity degree of the coastline to oil pollution, retention characteristics of oil pollution and difficulty degree of oil pollution removal;
the biological resources include animals, rare plants and habitats sensitive to oil pollution; and
the human activity resources refer to specific regions that have additional sensitivity and value as a result of being exploited and utilized by human beings.

In a second aspect, an oil spill risk early warning system is provided, which includes an oil spill prediction early warning module, an emergency decision support module, a database module and a system operation guarantee module;
the oil spill prediction early warning module is configured to backstep an oil spill trajectory, find an oil spill source, predict an oil spill trajectory, predict a property change, early warn a sensitive resource; specifically, remotely sense and monitor the offshore oil spill, monitor the location and amount of the oil spill, the area and direction of the oil film, and predict the oil film trend;
the emergency decision support module is configured to generate a cleaning solution, simulate cleaning effects, and analyze historical cases; and hierarchically consists of three levels: the national level, the regional level and the local level, and each level has its own emergency plan;
the database module is configured to obtain hydrometeorological data, oil product information, an oil spill handling method, oil spill handling equipment, emergency resource configuration, and environment sensitive resources; and
the system operation guarantee module is configured to acquire meteorological field data, marine environment forecast, hardware equipment, and expert consultation.

Further, in the oil spill prediction early warning module, based on an oil spill drift and diffusion model, an oil spill weathering model and an environmental sensitive resource map, a drift and diffusion trajectory and physico-chemical property changes of the oil spill on the sea surface are predicted, the sensitive resource pollution early warning is performed, a drift path of an unknown oil film on the sea surface is backstepped, and an oil spill pollution source is traced back.

Advantageous effects of the present disclosure are:
1. The method of the present disclosure can accurately and timely estimate the risk of oil spill, and send out an early warning in a timely manner, which is beneficial to timely response and has important significance for environmental protection and human environment restoration.
2. Based on the oil spill drift and diffusion model, the oil spill weathering model and the environment sensitive resource map, the system of the disclosure can predict the oil spill drift and diffusion track and the physico-chemical property changes on the sea surface, carry out the sensitive resource pollution early warning, backstep the drift path of the unknown oil film on the sea surface, and trace the oil spill pollution source. The structure is simple, functions are perfect, and the application prospect is good.

### BRIEF DESCRIPTION OF FIGURES

FIG. 1 is a flow chart of the method of the present disclosure;

FIG. 2 is an environment-sensitive resource distribution map according to Embodiment 1 of the present disclosure;

FIG. 3 is a water surface pollution probability distribution diagram according to Embodiment 1 of the present disclosure;

FIG. 4 is a statistical result diagram of the minimum time when the water surface is polluted according to Embodiment 1 of the present disclosure; and

FIG. 5 is a structural schematic diagram of the system according to the present disclosure.

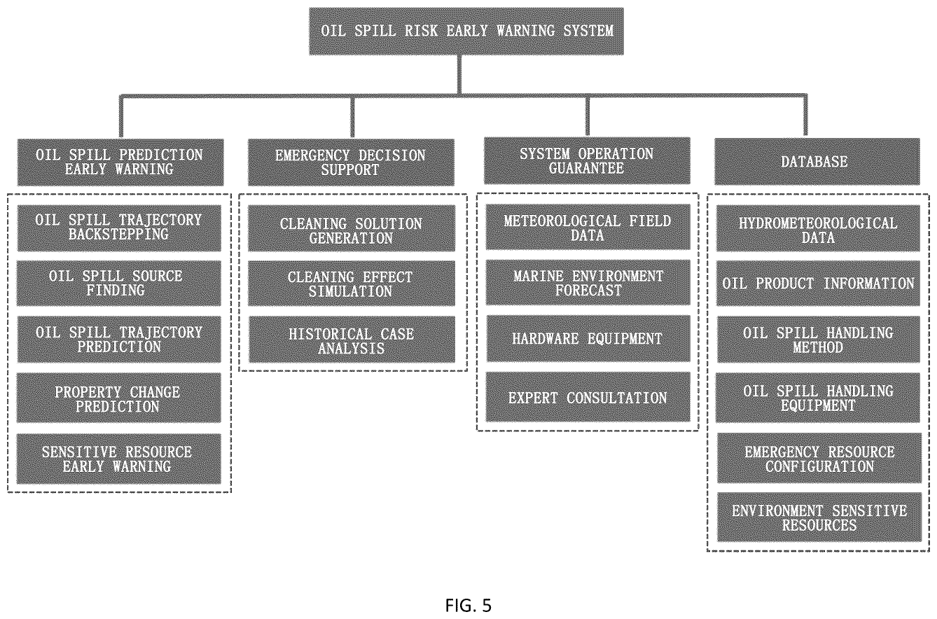

### DETAILED DESCRIPTION

Specific embodiments of the disclosure are described below, to facilitate the understanding of the present disclosure by those skilled in the art, it will be understood, however, that the disclosure is not limited to the scope of the specific embodiments, and that various modifications will become apparent to those skilled in the art without departing from the spirit and scope of the disclosure as defined and determined by the appended claims, and all disclosures which utilize the inventive concept are intended to be protected thereby.

### Embodiment 1

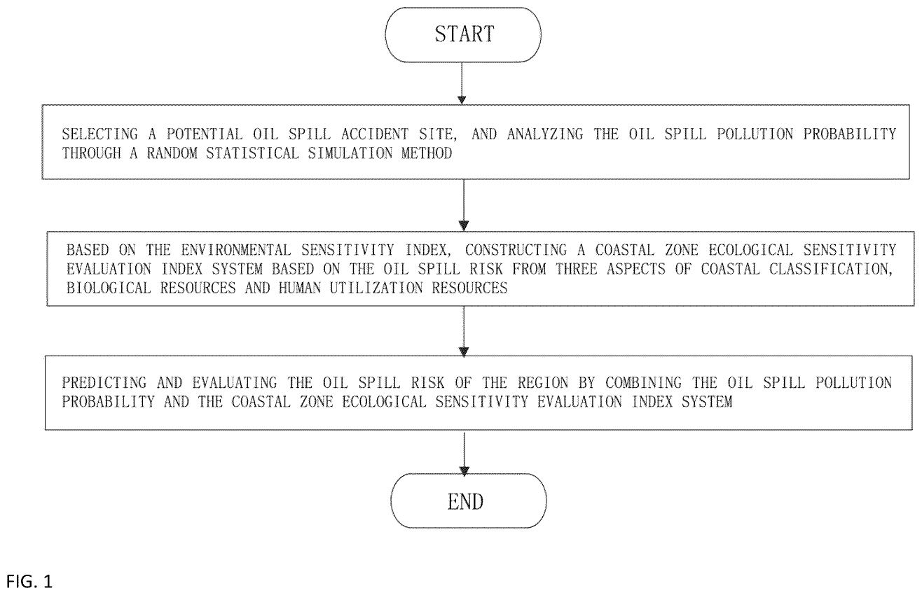

Referring to FIG. 1, there is provided an oil spill risk prediction method based on an environmental sensitivity index, the method including the following steps:
step 1, a potential oil spill accident site is selected, and the oil spill pollution probability is analyzed through a random statistical simulation method;
step 2, based on the environmental sensitivity index, a coastal zone ecological sensitivity evaluation index system is constructed based on the oil spill risk from three aspects of coastal classification, biological resources and human utilization resources; and
step 3, the oil spill risk of the region is predicted and evaluated by combining the oil spill pollution probability and the coastal zone ecological sensitivity evaluation index system.

Specifically, the random scenario simulation method is developed on the basis of the typical scenario simulation method. This method simulates the drift and diffusion trajectory of hundreds of random scenarios for each oil spill site, and the occurrence time of each accident scenario is uncertain. The wind speed, wind direction and flow field data at any time in the past few years are randomly selected. The main methods and processes of random scenario simulation statistics for oil spill pollution are as follows:
(1) a site of a possible oil spill accident is selected according to the ship collision accident density, and the sea area around the oil spill accident that may be affected by pollution is divided into a plurality of rectangular grids;
(2) drift and diffusion trajectory simulation calculations of not less than 300 different scenarios in the last three years are performed for the oil spill accident, the occurrence time of each accident scenario being uncertain, at any moment in the past three years, the hourly monitoring data of a sea surface wind field under the corresponding conditions of wind speed and wind direction, and the flow field data are randomly selected, calculation region tidal current field simulation is adopted to calculate a result, wherein oil film drift elapsed time of each calculation grid unit and a pollution frequency parameter are calculated and recorded in each accident scenario simulation; and
(3) according to the formula:

$$P ( i , j ) = \frac{M ( i , j )}{n} \times 100 \%$$

$$T ( i , j ) = Min \{ {T ( i , j )}_{n} \} , n = 1 , 2 , … , N$$

the pollution probability p (i, j) of the grid (i, j) by oil spill, and the minimum time T (i, j) for an oil film to drift to the grid (i, j) in N simulations are acquired; wherein i, j are delineated plane grid numbers; N is the total number of accident scenario simulations; M (i, j) is the number of times that the oil film drifts and diffuses to the grid (i, j) in N simulations.

Further, in step 2, the coastline classification are coastline environment sensitivity grading indices divided by certain criteria according to the sensitivity degree of the coastline to oil pollution, retention characteristics of oil pollution and difficulty degree of oil pollution removal;
the biological resources include animals, rare plants and habitats sensitive to oil pollution; and
the human activity resources refer to specific regions that have additional sensitivity and value as a result of being exploited and utilized by human beings.
Furthermore, in step 3, eco-environmental sensitivity refers to the reflection degree of the ecosystem to the interference of human activities and the change of natural environment, indicating the difficulty and possibility of regional eco-environmental problems. In essence, its evaluation is to identify the potential ecological and environmental problems under the background of the current natural environment and implement them in specific spatial regions. In sensitive regions, the ecosystem is easy to damage and ecological environment problems are easy to occur, which are the focus of ecological environment protection and restoration, and are also areas where human activities are limited or prohibited. The damage caused by oil spill varies with the pollution degree. Therefore, because of the differences in geology, topography, biology and ecology, the coasts have different sensitivity degrees to oil spill, and the degree of environmental pollution and damage is also different. On the basis of the NOAA environmental sensitivity index and related research, the coastal zone ecological sensitivity evaluation index system based on oil spill risk is constructed from three aspects: coastal classification, biological resources and human utilization resources.

### (1) Coastal Classification

The vulnerability of a specific coastline is usually considered from the coastline type (sediment, particle size, slope, area), the shielding degree of the coast to wave and tidal energy, the organisms around the coastline and their sensitivity to oil, and the difficulty of removal. All these factors are used to determine the relative sensitivity of the coastline. Therefore, the grading of sensitivity degree should consider many interrelated factors such as physical environment, sediment, coastline type, biological type, sediment migration, biological fate and influence, etc.

### (2) Biological Resources

The status of biological resources is an important content to determine the sensitivity degree of oil spill in this region, which mainly refers to the important biological categories that may be affected by oil spill. In coastal areas, all kinds of organisms are widely distributed, and many organisms are very vulnerable to oil pollution. However, because some organisms may occupy a considerable region, which is mixed with all kinds of animals and plants, the sensitivity identification is not clear, so it is necessary to select regions with special significance or main representative species, specifically including: marine biological species which are threatened by harmful substances and are on the verge of extinction; high natural reproduction area of marine organisms; spawning and feeding areas for important marine biological species, migration areas for seabirds and marine mammals, and key living areas for rare or fragile ecosystems such as coral reefs, seagrass beds, mangroves, wetlands, fish schools, etc.

### (3) Resource Utilization Types

Human utilization resources refer to all related human activities and related facilities that may be affected by oil spill. Oil spill pollution can also have a significant impact on human use of resources, especially fisheries and sightseeing. Among them, except for fishing grounds (fishing and aquaculture) and protected areas, which are polluted or impacted by development to result in reduction of biological resources and catch decrease, other human utilization resources are not impacted positively, but most of the original functions are affected, such as landscaping, recreation, sightseeing, etc., which may be unattractive due to pollution, so the sensitivity degree is not obvious, while important habitats, protected areas, fishing areas and other areas are sensitive areas for protection or priority cleaning.

In this embodiment, environment sensitive grading criteria are also provided:

### (1) Principle

With respect to environmental resources that are likely to be affected by the oil spill, the sensitivity degree is determined on the basis of the importance of the resource itself, and at the same time, the degree of harm that may be caused by the oil spill is appropriately taken into account. Sensitivity therefore depends mainly on the ecological, economic and special values of the resource environment itself.

### (2) Determination Method of Sensitivity Degree and Resource Classification

### 1) Coastline Classification

After oil pollution comes into contact with various coasts, according to the residual situation of oil pollution after being washed by waves, and whether it is easy to remove, the sensitive scale is defined and the coastline is classified. Referring to the ESI guidelines of NOAA in the United States, combined with the study region characteristics and data acquisition conditions, the coastline is divided into three categories according to the difficulty of cleaning oil pollution. Category 1 represents the lowest sensitivity, indicating that oil pollution is easy to wash by waves and can disappear naturally in the short term without deliberate cleaning. Category 3 represents the highest sensitivity, indicating that oil pollution is easy to stick to plants or deposits, can be maintained for a long time, and cannot be cleaned by heavy machinery, as shown in Table 1 for details.

TABLE 1
Coastline Type Classification

| Environmental | | |
|---|---|---|
| Sensitivity Index | | Coastline Types |
| 3 | Extremely | Exposed tidal flat, masked tidal flat, mud land, |
| | strong | sea water wetland belt, mangrove forest belt, |
| | | fresh water wetland, masked non-permeable |
| | | andsemi-permeable rock coast, artificial coast |
| 2 | Strong | Fine sand beach (slope > 5°), coarse sand |
| | | beach (slope > 5°), sand and gravel mixed |
| | | beach, stone beach (large, medium, |
| | | small stone diameters) |
| 1 | General | Exposed rock cliff, artificial coast, |
| | | exposed rock platform |

### 2) Biological Resources

For creatures vulnerable to oil pollution or rare species (such as submerged aquatic plants and animals or corals) and their habitats, the determination of sensitivity degree depends on the resource value itself. Therefore, the richness and resource value are evaluated to define the sensitive scale and classify the resource. Resource value mainly includes economic value, ecological value and special value. When considering the value function, the economic value, ecological value and special value are divided into three levels from high to low for classification and evaluation (Table 2). Finally, the three types of values of environmental resources are comprehensively considered for classification.

TABLE 2
Biological Resource Classification

| Environmental | | | Biological species |
|---|---|---|---|
| Sensitivity Index | | Biological Resource Types | susceptible to impact |
| 3 | Extremely | Mainly refers to environmental | Coral, bivalve shellfish, |
| | strong | resources that have high ecological | decapod crustacean shrimp |
| | | value while having special value, | crab (with massive deaths |
| | | such as worldwide rare and | or long-lasting effects) |
| | | endangered species, etc. | |
| 2 | Strong | Mainly refers to environmental | Large plants, barnacles |
| | | resources with very high ecological | (injured but potentially |
| | | value or with special value, less | non-lethal) |
| | | domestically distributed or with | |
| | | special protection value, such as | |
| | | national nature reserves; important | |
| | | ecological conservation zones, etc. | |
| 1 | General | Mainly refers to resources with very | Annelids, gastropods, |
| | | high economic value, provincial and | copepods (no obvious |
| | | municipal natural reserves, etc. | reaction) |

### 3) Resource Utilization Types

According to the coastal land use patterns, the sensitivity degree of coastal land to oil pollution is defined and the type is classified. The main basis is embodied in the special economic value, the importance of tourism and entertainment, and the great significance to the survival of local residents. The economic loss caused by oil spill pollution depends on the economic benefits generated by the resources themselves, the cost of pollution cleaning and the cost of resource restoration. Most of the resources related to human activities can be quantitatively evaluated through economic value (Table 3).

TABLE 3
Resource Utilization Types

| Environmental | | |
|---|---|---|
| Sensitivity Index | | Resource Utilization Types |
| 3 | Extremely | Mainly refers to environmental resources with |
| | strong | certain ecological value, economic value, |
| | | including some important tourist scenic |
| | | areas, important seafood culture areas. |
| 2 | Strong | Marine geological relics and paleontological |
| | | relics with certain appreciation value and |
| | | cultural value |
| 1 | General | Human utilization resources with |
| | | higher economic value |

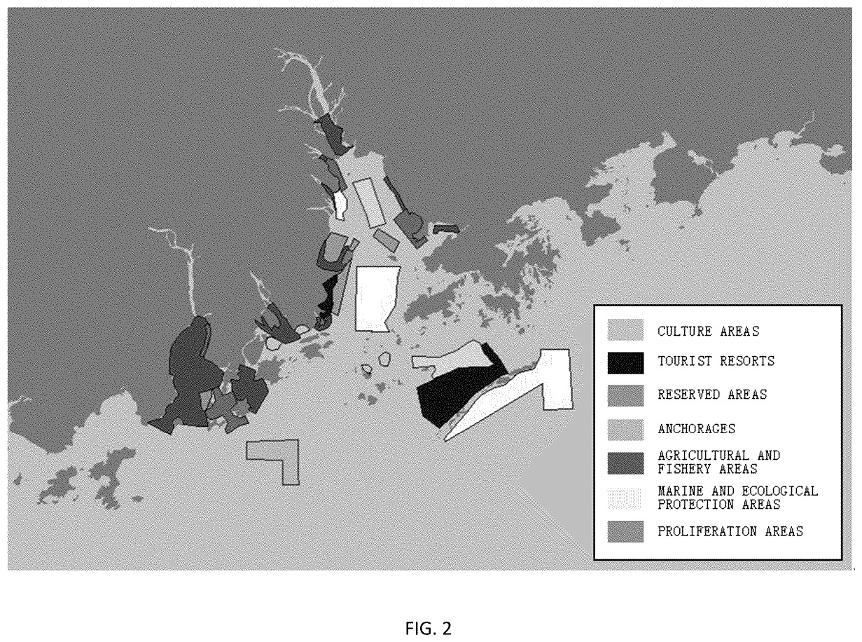

In this embodiment, the environment sensitivity index is graded into 5 levels according to the environment-sensitive resource distribution situation of the Guangdong-Hong Kong-Macao Greater Bay Area, as detailed in Table 4, and the sensitive resource distribution situation is shown in FIG. 2.

TABLE 4
Environment Sensitivity Grading

| Environmental | |
|---|---|
| Sensitivity Index | Types |
| 1 | Marine and ecological |
| | protection areas |
| 2 | Agricultural and |
| | fishery areas |
| 3 | Proliferation areas, |
| | reserved areas |
| 4 | Tourist resorts |
| 5 | Harbor shipping areas |
| | (anchorages) |

Because the migration and fate of the oil spill are affected by many uncertain factors such as time, place, quantity, wind and current, a random statistical simulation method is used to analyze the probability distribution of accident pollution impact, drift and diffusion time and coastline pollution probability distribution.

300 times of scenario drift and diffusion trajectory simulation are carried out on the oil spill site, and the accident time is randomly selected at any time in the past 3 years. Meteorological data use wind field data from 00:00 on Jan. 1, 2018 to 00:00 on Jan. 1, 2021 obtained from the American Environmental Forecasting Center. See Table 5 for model calculation parameters.

TABLE 5
Random Statistical Model Calculation Parameter Table

| Parameters | Taken values |
|---|---|
| Number of random | 300 times |
| simulations | |
| Length of | 3 years (Jan. 1, 2018, |
| meteorological | Jan. 1, 2021) |
| conditions | |
| Site of | Inbound and |
| oil spill | outbound waterways |
| Minimum | 0.01 g/m² |
| statistical | |
| threshold | |

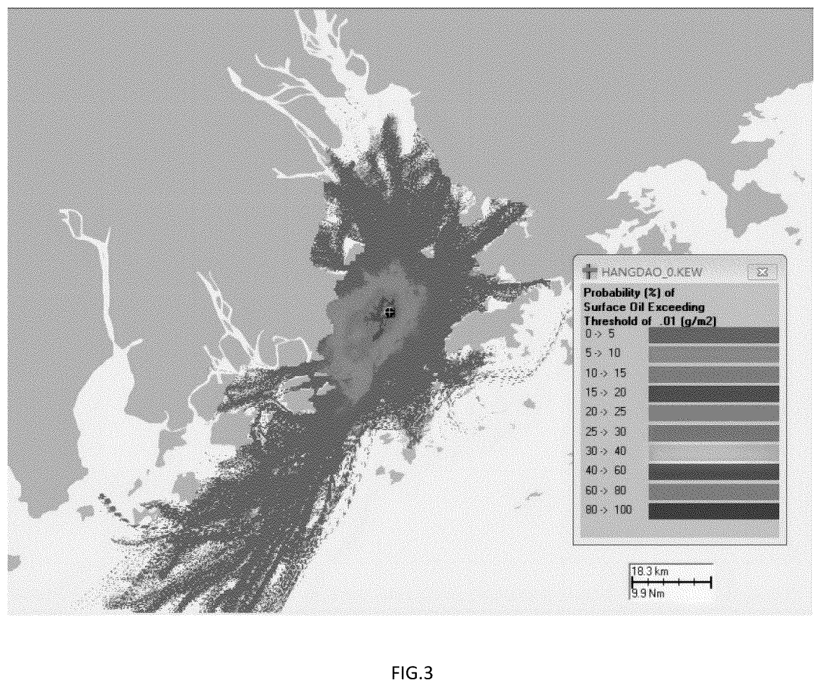

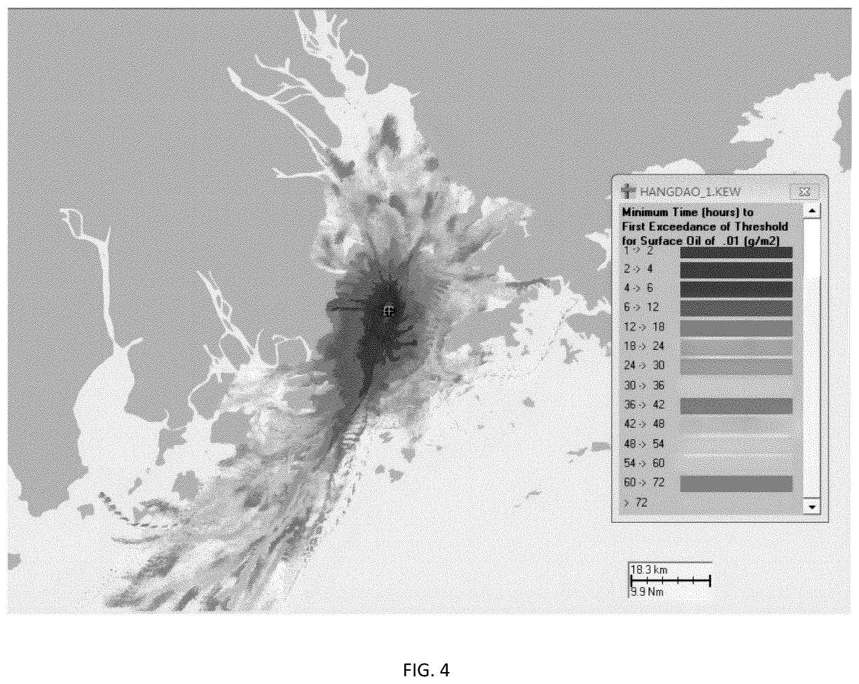

Based on the random statistical simulation results, the probability of pollution of the water surface is shown in FIG. 3, and the minimum time for water surface pollution after an accident is shown in FIG. 4.

### Embodiment 2

Referring to FIG. 2, an oil spill risk early warning system is provided, which includes an oil spill prediction early warning module, an emergency decision support module, a database module and a system operation guarantee module;
the oil spill prediction early warning module is configured to backstep an oil spill trajectory, find an oil spill source, predict an oil spill trajectory, predict a property change, early warn a sensitive resource; specifically, remotely sense and monitor the offshore oil spill, monitor the location and amount of the oil spill, the area and direction of the oil film, and predict the oil film trend;
the emergency decision support module is configured to generate a cleaning solution, simulate cleaning effects, and analyze historical cases; and hierarchically consists of three levels: the national level, the regional level and the local level, and each level has its own emergency plan;
the database module is configured to obtain hydrometeorological data, oil product information, an oil spill handling method, oil spill handling equipment, emergency resource configuration, and environment sensitive resources; and
the system operation guarantee module is configured to acquire meteorological field data, marine environment forecast, hardware equipment, and expert consultation.

Specifically, after oil spill leaks into the sea, it will drift and diffuse under the action of wind, waves and currents, so accurate acquisition of dynamic information of the oil film on the sea surface plays a key role in early warning of oil spill pollution. Based on the oil spill drift and diffusion model, the oil spill weathering model and the environmental sensitive resource map, this system can predict the drift and diffusion trajectory and physico-chemical property changes of the oil spill on the sea surface, carry out early warning of sensitive resource pollution, and can also backstep the drift path of unknown oil film on the sea surface and trace back the pollution source of oil spill.

### (1) Oil Spill Drift and Diffusion Model

Considering the effects of wind, currents and waves, the model adopts “a particle method” to simulate the drift and diffusion behavior of oil spill on the sea surface. Assuming that (Xn, Yn) is the horizontal position of the particle at the beginning of the n-th calculation step, the horizontal position of the oil particle at the end of the calculation step can be expressed as:

$${x}_{n}^{′} = {x}_{n} + u Δ t + ξ \sqrt{6 {K}_{H} Δ t}$$

$${y}_{n}^{′} = {y}_{n} + v Δ t + ξ \sqrt{6 {K}_{H} Δ t}$$

The model operation uses a multi-source meteorological data acquisition solution, is mainly based on the wind field data of the National Centers for Environmental Prediction (NCEP), and also includes manual input and historical data. When calculating the oil film diffusion area, the maximum diffusion areas of oil particles are projected and superimposed, and the range where the superimposed thickness of the oil film is greater than 0.05 μm is the visible area of the oil film. In the calculation process, the interaction between the oil film and coast is considered, and whether the oil particle goes ashore is judged by whether the line connecting the position point at the beginning of each calculation step and the position point at the end of each calculation step intersects with the coastline. For the oil particles on shore, the number of oil particles staying on shore and returning to the sea surface is calculated by taking into account the coastline type, wind, currents, sea waves and oil product properties.

### (2) Emergency Decision Support

Due to the difference of oil spill types, sea conditions, meteorological conditions and site environment, it is very difficult for emergency personnel to make emergency decisions. This system quantifies the relationship between many factors and targets of oil spill cleaning by establishing a model of oil spill cleaning technology optimization solution generation, an emergency resource calling analysis model and an oil spill cleaning effect model, and intelligently retrieves and fuses various data information. Through a man-machine dialogue mode, it can provide all-round information support for oil spill emergency optimization solutions and emergency decision-making. In the process of operation, the commander can formulate one or more sets of emergency plans by modifying the site conditions, mission objectives and other parameters.

Many factors need to be considered when choosing the cleaning technology, and the related factors should be comprehensively evaluated. The factors affecting the selection of cleaning technology can be divided into two categories: technical applicability and environmental applicability. Through the establishment of a fuzzy multi-level comprehensive evaluation model, various cleaning technologies are scored for comprehensive evaluation, and a reasonable cleaning technology is selected according to the scored value.

After the oil spill cleaning technology is determined, appropriate oil spill cleaning equipment and emergency personnel are selected for each cleaning technology. By building a multi-objective decision-making model, an emergency resource calling solution is established for the cleaning devices and their environmental impact conditions corresponding to each cleaning technology, including the information of equipment type and quantity, personnel quantity, where to call equipment and personnel, etc. At the same time, the determined calling solution is evaluated and sorted from the aspects of cost, time and applicability.

### (3) System Functions

The following may be provided in the prediction process:
Oil film dynamics: display modes including the oil particles, oil film residues, oil film paths, visible area and area residues;
Sea state information: including the instant wind field and flow field;
Oil film changes: including the residual oil amount, visible area, swept sea area and drift distance;
Oil product information: including the evaporation rate, water cut, density change and viscosity change;
Calculation record: recording the oil film center point position in unit of calculation step; and
Early warning information: sensitive area information affected by the oil film.

The method of the present disclosure can accurately and timely estimate the risk of oil spill, and send out an early warning in a timely manner, which is beneficial to timely response and has important significance for environmental protection and human environment restoration.

Based on the oil spill drift and diffusion model, the oil spill weathering model and the environment sensitive resource map, the system of the disclosure can predict the oil spill drift and diffusion track and the physico-chemical property changes on the sea surface, carry out the sensitive resource pollution early warning, backstep the drift path of the unknown oil film on the sea surface, and trace the oil spill pollution source. The structure is simple, functions are perfect, and the application prospect is good.

It will be apparent to those skilled in the art that the present disclosure is not limited to the details of the foregoing exemplary embodiments, and that the present disclosure can be embodied in other specific forms without departing from the spirit or essential characteristics thereof. The embodiments are therefore to be considered in all respects as illustrative and not restrictive, the scope of the disclosure being indicated by the appended claims rather than by the foregoing description, and all changes which come within the meaning and range of equivalency of the claims are therefore intended to be embraced therein.

Furthermore, it should be understood that, while this description is described in terms of embodiments, however, not every embodiment contains only one independent technical solution, the description is made for clarity only, and those skilled in the art should take the description as a whole, and the technical solutions in each embodiment can also be appropriately combined to form other embodiments that can be understood by those skilled in the art.

What is claimed is:

1. An oil spill risk prediction method based on an environmental sensitivity index, comprising the following steps:
step 1, selecting a potential oil spill accident site, and analyzing the oil spill pollution probability through a random statistical simulation method;
step 2, based on the environmental sensitivity index, constructing a coastal zone ecological sensitivity evaluation index system based on the oil spill risk from three aspects of coastal classification, biological resources and human utilization resources; and
step 3, predicting and evaluating the oil spill risk of the region by combining the oil spill pollution probability and the coastal zone ecological sensitivity evaluation index system.

2. The oil spill risk prediction method based on an environmental sensitivity index according to claim 1, wherein, the method of step 1 specifically comprises the following sub-steps:
step 1-1, selecting a site of a possible oil spill accident according to the ship collision accident density, dividing the sea area around the oil spill accident that may be affected by pollution into a plurality of rectangular grids;
step 1-2, performing drift and diffusion trajectory simulation calculations of not less than 300 different scenarios in the last three years for the oil spill accident, the occurrence time of each accident scenario being uncertain, randomly selecting, at any moment in the past three years, the hourly monitoring data of a sea surface wind field under the corresponding conditions of wind speed and wind direction, and the flow field data, and adopting calculation region tidal current field simulation to calculate a result, wherein oil film drift elapsed time of each calculation grid unit and a pollution frequency parameter are calculated and recorded in each accident scenario simulation; and
Steps 1-3, according to the formula:
$$P ( i , j ) = \frac{M ( i , j )}{n} \times 100 \%$$
$$T ( i , j ) = Min \{ {T ( i , j )}_{n} \} , n = 1 , 2 , … , N$$
acquiring the pollution probability p (i, j) of the grid (i, j) by oil spill, and the minimum time T (i, j) for an oil film to drift to the grid (i, j) in N simulations; wherein i, j are delineated plane grid numbers; N is the total number of accident scenario simulations; M (i, j) is the number of times that the oil film drifts and diffuses to the grid (i, j) in N simulations.

3. The oil spill risk prediction method based on an environmental sensitivity index according to claim 1, wherein, in step 2, the coastline classification are coastline environment sensitivity grading indices divided by certain criteria according to the sensitivity degree of the coastline to oil pollution, retention characteristics of oil pollution and difficulty degree of oil pollution removal;
the biological resources comprise animals, rare plants and habitats sensitive to oil pollution; and
the human activity resources refer to specific regions that have additional sensitivity and value as a result of being exploited and utilized by human beings.

4. An oil spill risk early warning system, comprising an oil spill prediction early warning module, an emergency decision support module, a database module and a system operation guarantee module;
the oil spill prediction early warning module is configured to backstep an oil spill trajectory, find an oil spill source, predict an oil spill trajectory, predict a property change, early warn a sensitive resource; specifically, remotely sense and monitor the offshore oil spill, monitor the location and amount of the oil spill, the area and direction of the oil film, and predict the oil film trend;
the emergency decision support module is configured to generate a cleaning solution, simulate cleaning effects, and analyze historical cases; and hierarchically consists of three levels: the national level, the regional level and the local level, and each level has its own emergency plan;
the database module is configured to obtain hydrometeorological data, oil product information, an oil spill handling method, oil spill handling equipment, emergency resource configuration, and environment sensitive resources; and
the system operation guarantee module is configured to acquire meteorological field data, marine environment forecast, hardware equipment, and expert consultation.

5. The oil spill risk early warning system according to claim 4, wherein, in the oil spill prediction early warning module, based on an oil spill drift and diffusion model, an oil spill weathering model and an environmental sensitive resource map, a drift and diffusion trajectory and physico-chemical property changes of the oil spill on the sea surface are predicted, the sensitive resource pollution early warning is performed, a drift path of an unknown oil film on the sea surface is backstepped, and an oil spill pollution source is traced back.
